(19) United States
(12) Patent Application Publication
(10) Pub. No.: US 2025/0005311 A1
(43) Pub. Date: Jan. 2, 2025

(54) PRINTING SYSTEM, INFORMATION PROCESSING APPARATUS AND METHOD OF CONTROLLING THE SAME, AND STORAGE MEDIUM

(71) Applicant: CANON KABUSHIKI KAISHA, Tokyo (JP)

(72) Inventor: KAZUFUMI KOBASHI, Tokyo (JP)

(21) Appl. No.: 18/752,543

(22) Filed: Jun. 24, 2024

(30) Foreign Application Priority Data
Jun. 30, 2023 (JP) 2023-108521

(51) Int. Cl. G06K 15/02; G06T 7/00

(52) U.S. Cl. CPC G06K 15/1878; G06K 15/027; G06T 7/001; G06T 2207/10024; G06T 2207/30144

(57) ABSTRACT

The present invention provides an information processing apparatus and a method of controlling an information processing apparatus. The information processing apparatus controls execution of a color inspection for inspecting a color quality state at a time of printing in an image forming apparatus, controls to determine one of a plurality of color adjustment processes for adjusting the color quality state of an image forming apparatus in accordance with the quality state determined by the color inspection, and causes the image forming apparatus to execute the determined color adjustment processes. The image forming apparatus can execute any one of the plurality of color adjustment processes in which downtimes of the image forming apparatus differ for each of the color adjustment processes from each other.

### BACKGROUND OF THE INVENTION

### Field of the Invention

The present invention relates to a printing system, an information processing apparatus and a method of controlling the same, and a storage medium.

### Description of the Related Art

In commercial printing, it is necessary to accurately reproduce color tones in printing using a printing device. Therefore, at the printing site, the state of the color tone of the printing device is periodically inspected, and in a case where the printing device is in a state where the exact color tone cannot be reproduced, the reproducing state of the color tone of the printing device is adjusted, so that the printing device maintains a state where the correct color tone can be reproduced.

As a method for inspecting the color quality of a printed matter, there is a method in which a chart on which several color patches are printed is read by a colorimeter, and the read information is compared with a color standard of a printing industry or a color standard uniquely determined by a printing company. In this method, the average color difference of all patches and the maximum color difference in all patches are typically calculated from the comparison results, and the color quality is inspected by determining whether each of the color differences is less than or equal to an allowable value determined in advance by the user. In addition to the average color difference and the maximum color difference, inspection conditions may be determined from various viewpoints.

In addition, as a method of adjusting the reproducing state of the color tone, there is a typical method of stopping execution of a print job on a printing device and correcting the density and the gradation of the color so as to match the color standard. Since it takes a certain amount of time to perform color adjustment work and a print job cannot be executed during color adjustment, the downtime of the printing device increases. On the other hand, in recent years, in order to suppress the downtime of the color adjustment, a method has been proposed in which a colorimetry sensor is mounted in a printing device, color patches are inserted at regular intervals while executing a print job, and the printed density is corrected simply. Japanese Patent Laid-Open No. 2021-21820 describes reducing a waiting time of a user during color adjustment by adjusting an image quality of a printing unit in a case where an operation that has more user operations than a predetermined number is started.

According to the technology disclosed in Japanese Patent Laid-Open No. 2021-21820, it is possible to perform a time-consuming color adjustment while a user performs an operation on a printing device that requires a lot of time. Therefore, it is possible to reduce the waiting time of the user. However, the waiting time cannot be reduced thereby unless the user performs a time-consuming operation.

Conventionally, it is preferable to reduce the number of times that a color adjustment function having a large downtime is executed by executing a simple color adjustment function that reduces downtime as much as possible in accordance with the reproducing state of the color tone of the printing device to maintain the current state of the color tone. However, it is difficult to determine which color adjustment function is appropriate to execute at which timing based on the judgment of the user.

### SUMMARY OF THE INVENTION

Embodiments of the present disclosure eliminate the above-mentioned issues with conventional technology.

A feature of embodiments of the present disclosure is to provide a technique for automatically performing optimal color adjustment processing in accordance with results of color inspection.

According to embodiments of the present disclosure, there is provided a method of controlling an information processing apparatus, the method comprising: controlling execution of a color inspection for inspecting a color quality state at a time of printing in an image forming apparatus; controlling to determine one of a plurality of color adjustment processes for adjusting the color quality state of the image forming apparatus in accordance with the quality state determined by the color inspection, where downtimes of the image forming apparatus differ for each of the color adjustment processes from each other; and causing the image forming apparatus to execute the determined color adjustment processes.

According to embodiments of the present disclosure, there is provided a printing system comprising an information processing apparatus and an image forming apparatus for executing a print job from the information processing apparatus and performing printing, the information processing apparatus comprising: one or more first controllers including one or more first processors and one or more first memories, the one or more first controllers configured to: control execution of a color inspection for inspecting a color quality state at a time of printing in an image forming apparatus; control to determine one of a plurality of color adjustment processes for adjusting the color quality state of the image forming apparatus in accordance with the quality state determined by the color inspection, where downtimes of the image forming apparatus differ for each of the color adjustment processes from each other; and make an instruction to the image forming apparatus to execute the determined, color adjustment processes, and the image forming apparatus comprising: one or more second controllers including one or more second processors and one or more second memories, the one or more second controllers configured to: execute the color adjustment process that the information processing apparatus instructed.

According to embodiments of the present disclosure, there is provided an information processing apparatus, comprising: one or more controllers including one or more processors and one or more memories, the one or more controllers configured to: control execution of a color inspection for inspecting a color quality state at a time of printing in an image forming apparatus; control to determine one of a plurality of color adjustment processes for adjusting the color quality state of the image forming apparatus in accordance with the quality state determined by the color inspection, where downtimes of the image forming apparatus differ for each of the color adjustment processes from each other; and make an instruction to the image forming apparatus to execute the determined color adjustment.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a view for describing a configuration of a printing system, according to a first embodiment of the present invention.

FIG. 2 is a block diagram for describing a hardware configuration of a client computer, an automatic adjustment unit, an image forming apparatus, an image processing apparatus, a paper discharge apparatus, and a database, according to the first embodiment.

FIG. 3 is a functional configuration diagram of the client computer and the image processing apparatus, according to the first embodiment.

FIGS. 4A to 4C depict views illustrating an example of information that is necessary for a color inspection, which is saved in a database, according to the first embodiment.

FIG. 5 is a flowchart for describing processing for setting an optimal color adjustment function in accordance with a result of a color inspection in the system, according to the first embodiment.

FIG. 6 depicts a view illustrating an example of a color inspection screen, according to the first embodiment.

FIG. 7 depicts a view illustrating an example of a color inspection result screen, according to the first embodiment.

FIG. 8A depicts a view illustrating an example of a color adjustment function table, according to the first embodiment.

FIG. 8B depicts a view illustrating an example of a table for a relation between a color inspection result and a color adjustment, according to a first embodiment.

FIG. 9 is a flowchart for describing processing for setting an optimal color adjustment function in accordance with a result of a color inspection in the system, according to the second embodiment.

FIG. 10A depicts a view illustrating an example of a color adjustment function table, according to the second embodiment.

FIG. 10B depicts a view illustrating an example of a table for a relation between a color inspection result and a color adjustment, according to the second embodiment.

FIG. 11 depicts a view illustrating an example of a screen for setting a color adjustment method by which to perform a color adjustment method designation, according to the second embodiment.

FIGS. 12A and 12B are flowcharts for describing processing for setting an optimal color adjustment function in accordance with a result of a color inspection in the system, according to a third embodiment.

FIG. 13 depicts a view illustrating an example of a list of print jobs which are processed on the image processing apparatus which is saved in a database, according to the third embodiment.

FIG. 14 depicts a view illustrating an example of a warning screen displayed on a display unit of a client computer, according to the third embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure.

### First Embodiment

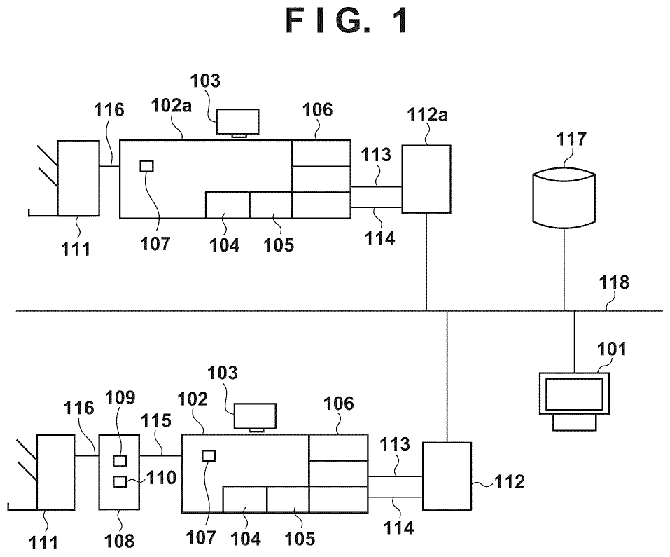

FIG. 1 depicts a view for describing a configuration of a printing system, according to a first embodiment of the present invention. The printing system includes a client computer 101, image forming apparatuses 102 and 102a, image processing apparatuses 112 and 112a, and a database 117. Here, since the image forming apparatuses 102 and 102a have the same hardware configuration, the respective parts of the image forming apparatuses are denoted by the same reference numerals. Further, the image processing apparatuses 112 and 112a have the same hardware configuration.

The client computer 101 is connected to the image processing apparatuses 112 and 112a and the database 117 on the same network via a network 118. The client computer 101 functions as an information processing apparatus that issues print processing and color inspection instructions to the image processing apparatuses 112 and 112a, and the like.

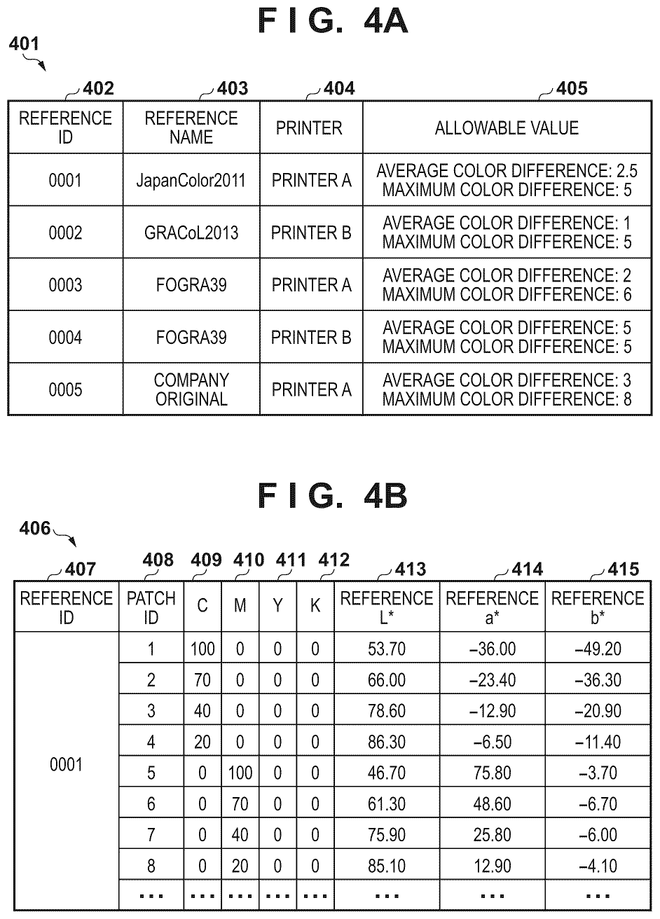

Information required for color inspection (detailed in FIGS. 4A to 4C below) and color inspection results are saved in the database 117 on the network, and that information is transmitted to the client computer 101 via the network 118. The information necessary for the color inspection and the color inspection results may be saved and managed in the client computer 101 instead of the database 117 on the network. Further, at the time of color inspection, the client computer 101 performs color inspection by giving print and colorimetry instructions of a chart on which color patches for color inspection are arranged to the image processing apparatuses 112 and 112a via the network 118 based on the set information.

The image forming apparatuses 102 and 102a are connected to the image processing apparatuses 112 and 112a respectively via a cable 113 and a cable 114. The image forming apparatuses 102 and 102a include a user interface (UI) panel (operation panel) 103, a paper feed deck 104, a paper feed deck 105, and a spectral sensor 107. An optional deck 106 composed of three paper feed stages is further connected to each of the image forming apparatuses 102 and 102a. The image forming apparatuses 102 and 102a are, for example, electrophotographic image forming apparatuses. The UI panel 103 is, for example, a user interface including a touch panel of an electrostatic capacitance method. The spectral sensor 107 is a sensor that irradiates a material with light and measures the reflectance, scatter, and absorbance of the spectrum to obtain information, and this sensor can be used for performing colorimetry on printed matter.

Further, the image forming apparatus 102 is connected to an automatic adjustment unit 108. The automatic adjustment unit 108 is connected to the image forming apparatus 102 via a cable 115. Furthermore, the automatic adjustment unit 108 includes two types of sensors, namely, a spectral sensor 109 and a CIS 110. The spectral sensor 109 has the same role as the spectral sensor 107 included in the image forming apparatus 102. “CIS” is an abbreviation for Contact Image Sensor and the CIS 110 is an image reading sensor. A paper discharge apparatus 111 is connected to the image forming apparatus 102a or the automatic adjustment unit 108 via a cable 116. Further, the paper discharge apparatus 111 includes several paper discharging trays, and is capable of loading products printed by the image forming apparatuses 102 and 102a.

A print job is generated by the client computer 101, transmitted to the image processing apparatuses 112 and 112a via the network 118, and managed by the image processing apparatuses 112 and 112a. The print job is transmitted from the image processing apparatuses 112 and 112a to the image forming apparatuses 102 and 102a via the cable 113 and the cable 114, and the image forming apparatuses 102 and 102a perform a process of printing on a sheet. The print job may be generated and managed in the image processing apparatuses 112 and 112a, transmitted to the image forming apparatuses 102 and 102a via the cable 113 and the cable 114, and managed by the image forming apparatuses 102 and 102a. In addition, a plurality of the image forming apparatuses 102 and 102a may be present on the network 118.

The form in which the client computer 101, the image forming apparatuses 102 and 102a, the image processing apparatuses 112 and 112a, and the database 117 according to the present embodiment are connected to each other is only an example, and various connection forms other than that described in the present embodiment are of course possible.

In the following description, the explanation will be based on a system configuration including the client computer 101, the image forming apparatus 102, the automatic adjustment unit 108, the paper discharge apparatus 111, the image processing apparatus 112, and the database 117.

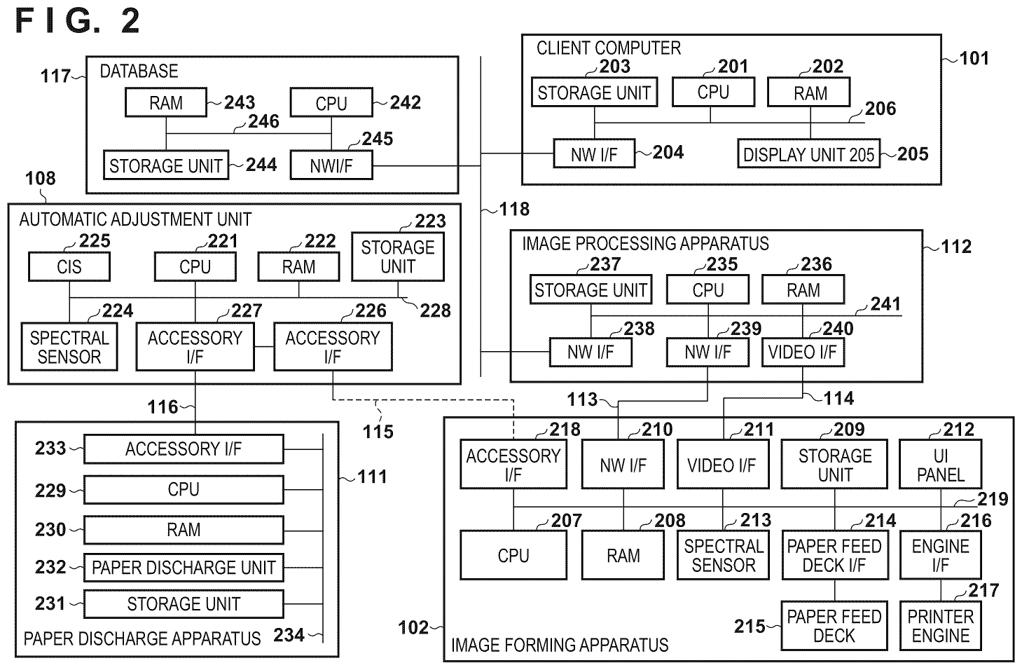

FIG. 2 is a block diagram for describing a hardware configuration of the client computer 101, the automatic adjustment unit 108, the image forming apparatus 102, the image processing apparatus 112, the paper discharge apparatus 111, and the database 117 according to the first embodiment.

First, the configuration of the client computer 101 will be described.

A CPU (Central Processing Unit) 201 is responsible for control of each unit of the client computer 101 via a system bus 206 and calculations. The CPU 201 is responsible for executing programs stored in a storage unit 203 and deployed into a Random Access Memory (RAM) 202. The RAM 202 is a type of typical volatile storage apparatus that can be directly accessed from the CPU 201 and is used as a work area of the CPU 201 and another temporary data storage area. The storage unit 203 functions as a temporary storage area and a working memory when the client computer 101 operates. A network interface (hereinafter, network (NW) I/F) 204 is connected via the network 118 to an NW I/F 238 of the image processing apparatus 112 which is on the network, and manages communication between the client computer 101 and the image processing apparatus 112. The NW I/F 204 is further connected to an NW I/F 245 of the database 117 on the network via the network 118, and is responsible for the communication between the client computer 101 and the database 117. A display unit 205 is a user interface for visually showing various kinds of information generated by the client computer 101. For example, a monitor display is included.

Next, a configuration of the image forming apparatus 102 will be described.

A CPU 207 is responsible for control of each unit of the image forming apparatus 102 via a system bus 219 and calculations. The CPU 207 is responsible for executing programs stored in a storage unit 209 and deployed into a RAM 208. The RAM 208 is a type of typical volatile storage apparatus that can be directly accessed from the CPU 207 and is used as a work area of the CPU 207 and another temporary data storage area. The storage unit 209 functions as a temporary storage area and a working memory when the image forming apparatus 102 operates.

An NW I/F 210 is connected to an NW I/F 239 of the image processing apparatus 112 via the cable 113, and manages communication between the image processing apparatus 112 and the image forming apparatus 102. A video I/F 211 is connected to a video I/F 240 of the image processing apparatus 112 via the video cable 114, and manages communication of image data between the image processing apparatus 112 and the image forming apparatus 102.

A UI panel (operation panel) 212 is a hardware configuration of the UI panel 103 of FIG. 1, and is a user interface for general operation of the image forming apparatus 102. In the first embodiment, it is assumed that the UI panel 212 includes a capacitive touch panel. A spectral sensor 213 is a hardware configuration of the spectral sensor 107 of FIG. 1, and performs colorimetry of a printed matter printed by the image forming apparatus 102. A paper feed deck I/F 214 is responsible for communicating with and controlling a paper feed deck 215. The paper feed deck 215 collectively refers to the paper feed decks 104 and 105 and the optional deck 106 of FIG. 1 as a hardware configuration. An engine I/F 216 is responsible for communicating with and controlling a printer engine 217.

An accessory I/F 218 is connected to an accessory I/F 226 of the automatic adjustment unit 108 via the cable 115 and is further connected to an accessory I/F 233 of the paper discharge apparatus 111 via the cable 116. That is, the image forming apparatus 102 communicates with the automatic adjustment unit 108 and the paper discharge apparatus 111 via the accessory I/Fs 218, 226, 227 and 233.

Next, a configuration of the automatic adjustment unit 108 will be described.

A CPU 221 is responsible for control of each unit of the automatic adjustment unit 108 via a system bus 228 and calculations. The CPU 221 is responsible for executing programs stored in a storage unit 223 and deployed into a RAM 222. The RAM 222 is a type of typical volatile storage apparatus that can be directly accessed from the CPU 221 and is used as a work area of the CPU 221 and another temporary data storage area. The storage unit 223 functions as a temporary storage area and a working memory at the time of a colorimetry operation and an adjustment operation. A spectral sensor 224 is a hardware configuration of the spectral sensor 109 of FIG. 1, and performs colorimetry of a printed matter printed by the image forming apparatus 102. A CIS 225 is a hardware configuration of the CIS 110 of FIG. 1, and captures an image of a printed matter printed by the image forming apparatus 102.

The accessory I/F 226 is connected to the accessory I/F 218 of the image forming apparatus 102 via the cable 115, and is responsible for communication and control between the automatic adjustment unit 108 and the image forming apparatus 102. The accessory I/F 227 is connected to the accessory I/F 233 of the paper discharge apparatus 111 via the cable 116, and is responsible for communication and control between the automatic adjustment unit 108 and the paper discharge apparatus 111.

Next, a configuration of the paper discharge apparatus 111 will be described.

A CPU 229 is responsible for control of each unit of the paper discharge apparatus 111 via a system bus 234 and calculations. The CPU 229 is responsible for executing programs stored in a storage unit 231 and deployed into a RAM 230. The RAM 230 is a type of typical volatile storage apparatus that can be directly accessed from the CPU 229 and is used as a work area of the CPU 229 and another temporary data storage area. The storage unit 231 functions as a temporary storage area and a working memory when the paper discharge apparatus 111 operates. A paper discharging unit 232 manages a paper discharging operation to a paper discharging tray included in the paper discharge apparatus 111, and monitoring and control of a stacking state of each tray. As described above, the paper discharge apparatus 111 communicates with the image forming apparatus 102 and the automatic adjustment unit 108 via the accessory I/Fs 233, 218, and 227.

Next, a configuration of the image processing apparatus 112 will be described.

A CPU 235 is responsible for control of each unit of the image processing apparatus 112 via a system bus 241 and calculations. The CPU 235 is responsible for executing programs stored in a storage unit 237 and deployed into a RAM 236. The RAM 236 is a type of typical volatile storage apparatus that can be directly accessed from the CPU 235 and is used as a work area of the CPU 235 and another temporary data storage area. The storage unit 237 functions as a temporary storage area and a working memory when the image processing apparatus 112 operates. The NW I/F 238 is connected to the NW I/F 204 of the client computer 101 and the NW I/F 245 of the database 117 via the network 118. The image processing apparatus 112 communicates with the client computer 101 via the NW I/F 238 and the NW I/F 204. The image processing apparatus 112 communicates with the database 117 via the NW I/F 238 and the NW I/F 245. The NW I/F 239 is connected to the NW I/F 210 of the image forming apparatus 102 via the cable 113, and manages communication between the image processing apparatus 112 and the image forming apparatus 102. The video I/F 240 is connected to the video I/F 211 of the image forming apparatus 102 via the video cable 114, and manages communication of image data between the image processing apparatus 112 and the image forming apparatus 102.

Next, a configuration of the database 117 will be described.

A CPU 242 is responsible for control of each unit of the database 117 via a system bus 246 and calculations. The CPU 242 is responsible for executing programs stored in a storage unit 244 and deployed into a RAM 243. The RAM 243 is a type of typical volatile storage apparatus that can be directly accessed from the CPU 242 and is used as a work area of the CPU 242 and another temporary data storage area. The storage unit 244 functions as a temporary storage area and a working memory when the database 117 operates. An NW I/F 245 is connected to the NW I/F 204 of the client computer 101 on the network via the network 118, and is responsible for the communication between the database 117 and the client computer 101. The NW I/F 245 is connected via the network 118 to the NW I/F 238 of the image processing apparatus 112 on the network, and manages communication between the database 117 and the image processing apparatus 112.

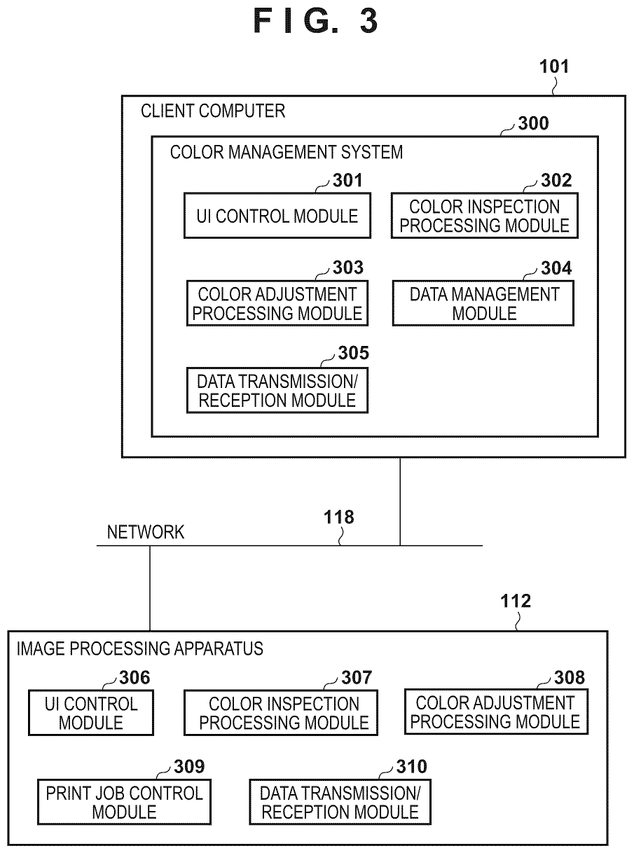

FIG. 3 is a functional configuration diagram of the client computer 101 and the image processing apparatus 112, according to the first embodiment. The functions of each of the functional units illustrated in FIG. 3 are achieved by the respective CPUs of the client computer 101 and the image processing apparatus 112 executing programs deployed into the RAMs.

A program for realizing a color management system 300 is installed in the storage unit 203 of the client computer 101, and when an instruction to execute the system is received, the program is deployed into the RAM 202 and executed by the CPU 201. The color management system 300 includes a UI control module 301, a color inspection processing module 302, a color adjustment processing module 303, a data management module 304, and a data transmission/reception module 305. The UI control module 301 outputs various user interfaces of the color management system 300 to the display unit 205, and performs a process of receiving an input from the user. The color inspection processing module 302 performs a process of generating an inspection job for performing color inspection and transmitting the inspection job to the image processing apparatus 112, and a process of comparing and inspecting the color quality state at the time of printing in the image processing apparatus 112 with a reference value based on the information of colors measured by the image forming apparatus 102. The color adjustment processing module 303 determines a color adjustment function to be executed, and performs a process of setting the color adjustment function to the image processing apparatus 112. The data management module 304 manages access and editing processing for various kinds of information related to color inspection and color adjustment. The data transmission/reception module 305 is responsible for transmitting/receiving data to/from the image processing apparatus 112.

Next, a function of the image processing apparatus 112 will be described.

The image processing apparatus 112 includes a UI control module 306, a color inspection processing module 307, a color adjustment processing module 308, a print job control module 309, and a data transmission/reception module 310. The UI control module 306 controls an output (for example, image display) to an output apparatus such as a display (not illustrated), and an input from an input apparatus such as a keyboard (not illustrated). The color inspection processing module 307 manages a process of transmitting color information of a color patch read by the spectral sensor 213 of the image forming apparatus 102 or the spectral sensor 224 of the optional automatic adjustment unit 108 to the color management system 300. The color adjustment processing module 308 is responsible for control of setting and execution of various color adjustment functions. The print job control module 309 performs control necessary for execution of a print job by the image forming apparatus 102, such as management and analysis of a print job received via the network 118, expansion into a raster image, compression and decompression of an image, and the like. Note that the print job includes not only printing of image and/or document created by a general user but also printing of a chart for performing color inspection. The data transmission/reception module 310 manages transmission and reception of various data to and from the client computer 101 and the image forming apparatus 102. The print job processed as necessary by the print job control module 309 is transmitted to the image forming apparatus 102 by the data transmission/reception module 310. The processes illustrated in each of the flowcharts described below are realized by the respective aforementioned CPUs functioning as the respective functional units by executing the programs deployed into respective corresponding RAMs.

FIGS. 4A to 4C depict views illustrating an example of information that is necessary for a color inspection, which is saved in the database 117, according to the first embodiment. This information is saved in the storage unit 244 of the database 117.

FIG. 4A illustrates an example of color reference data used when performing color inspection. A table 401 is an information table indicating what kind of information the color reference used when performing color inspection is saved as. A reference ID 402 is ID information for distinguishing the saved color reference. Although four-digit numbers are illustrated in this example, this is merely an example, and various other methods such as a combination of random characters may be used. A reference name 403 indicates the name of the saved color reference. A printer 404 indicates which printer (the image forming apparatus 102) is used to print a color reference and perform color inspection. Allowable values 405 indicate what allowable values are set for the saved color reference, such as an average color difference, a maximum color difference, and the like. Although only the average color difference and the maximum color difference are described in this example, various other allowable values such as that for the average color difference of a gray region may be adopted.

FIG. 4B illustrates some examples of data indicating what color reference values are held for various color patches in each color reference illustrated in FIG. 4A. A table 406 is an information table that associates color patches with color reference values for a color reference. A reference ID 407 is ID information for indicating which color reference the information table is for. In this example, it can be seen that when a matching ID is searched in the reference ID 402 of FIG. 4A, the information table 406 is for the color reference called “JapanColor2011”. A patch ID 408 is ID information for identifying color patches. Reference numerals 409 to 412 indicate Cyan (C), Magenta (M), Yellow (Y), and Black (K) for printing corresponding to respective patches, and signal values between 0 and 100 are saved therein. Reference numerals 413 to 415 each denote reference values (Lab values) in the Lab color space set in the color reference in a CMYK signal value combination. In this example, L=53.70, a=−36.00, and b=−49.20 are set as the reference values when the signal values of C=100 and M, Y, and K=0 are combined. These reference values are set to different values for each color reference.

FIG. 4C illustrates an example of color inspection result data for which values measured colorimetrically after each of the color patches illustrated in FIG. 4B is printed and color differences between reference values and the colorimetry values have been added. In FIG. 4C, the same reference numerals are used to denote the same data as in FIG. 4B.

Reference numerals 416 to 418 denote colorimetry values obtained by measuring each color patch. Reference numeral 419 denotes the color difference (AE) between the reference values of reference numerals 413 to 415 and the colorimetry values of reference numerals 416 to 418.

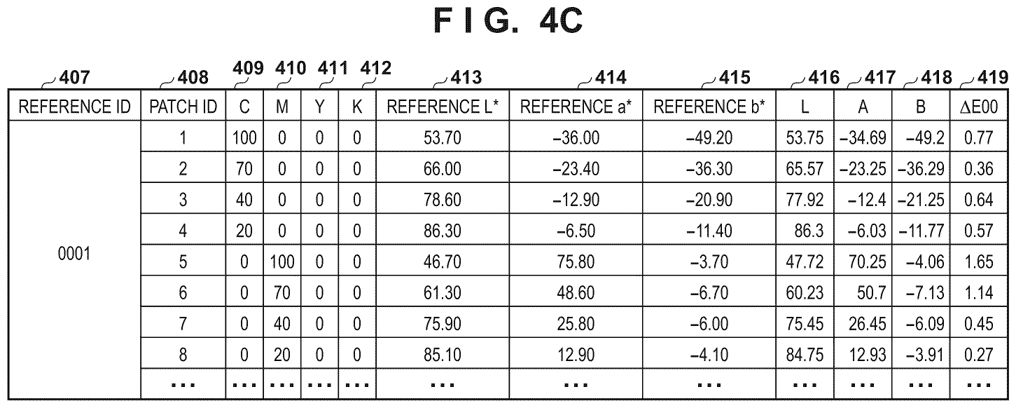

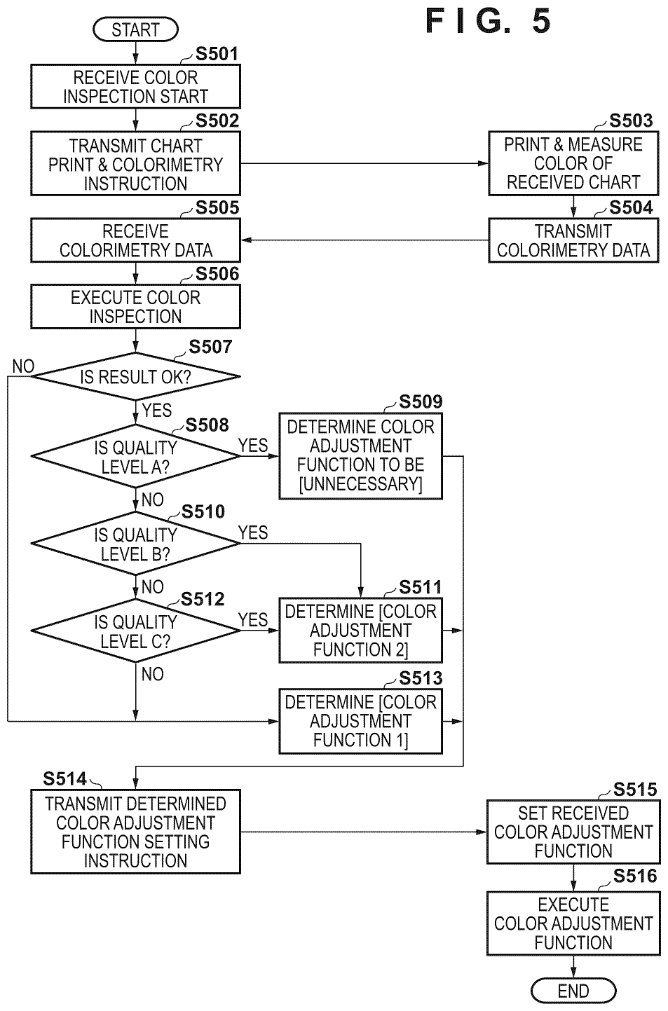

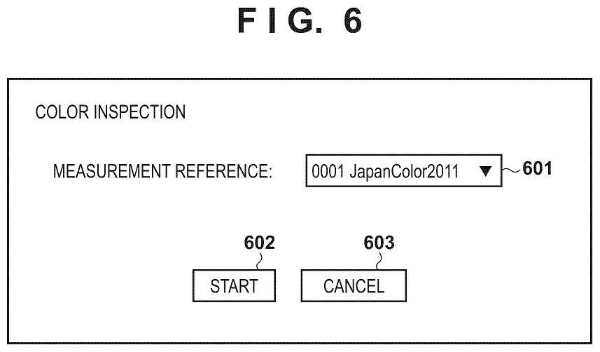

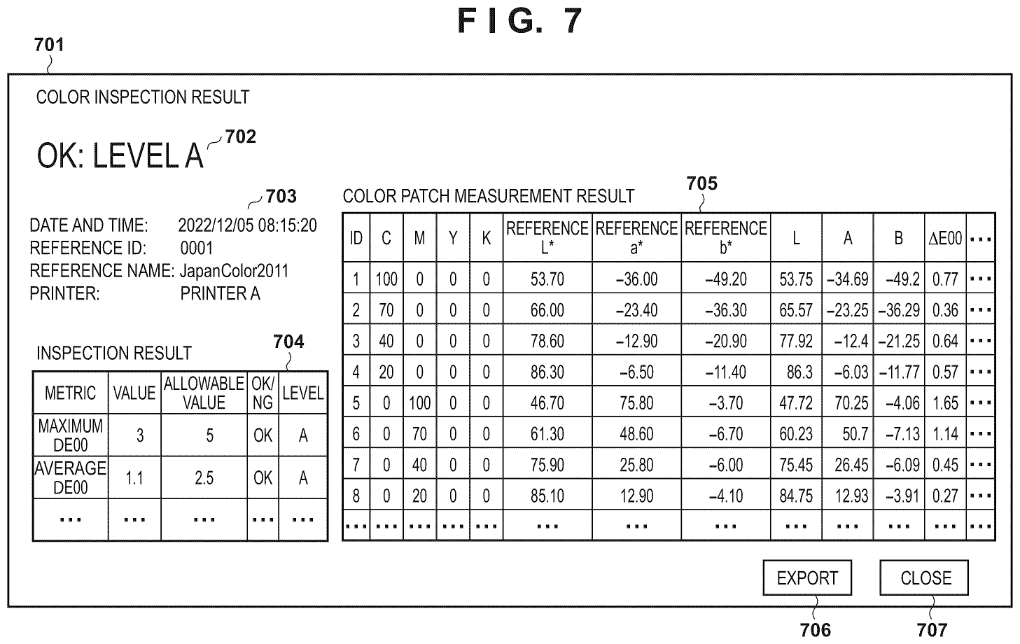

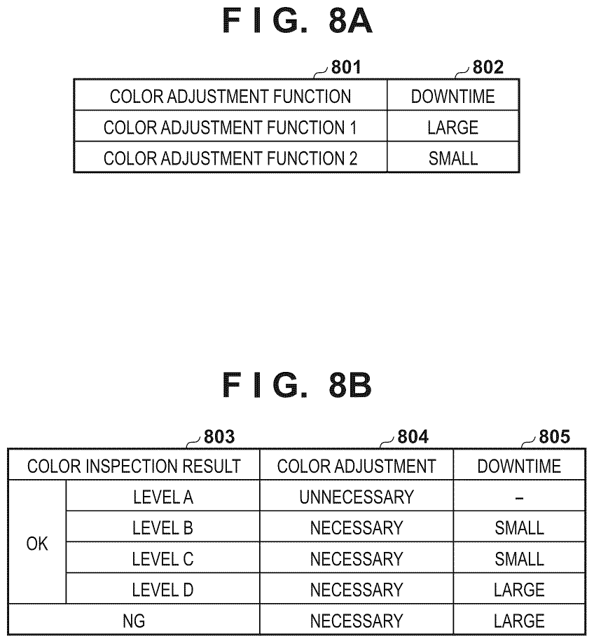

FIG. 5 is a flowchart for describing processing for setting an optimal color adjustment function in accordance with a result of a color inspection in the system, according to the first embodiment. The respective processing steps will be described referring to the color inspection screen of FIG. 6, the color inspection result screen of FIG. 7, and the color adjustment information of FIGS. 8A and 8B. As will be described in detail later, steps S503, S504, S515, and S516 are processing steps executed by the image processing apparatus 112 and the image forming apparatus 102, and the rest are processing steps executed by the color management system 300 of the client computer 101.

In step S501, the color management system 300 receives an instruction to begin executing the color inspection. At this time, the UI control module 301 displays the color inspection execution screen illustrated in FIG. 6 on the display unit 205. At this time, the data management module 304 obtains the color reference list illustrated in FIG. 4A from the database 117 via the network 118.

FIG. 6 depicts a view illustrating an example of a color inspection screen according to the first embodiment.

In this screen, “JapanColor2011”, described previously in FIG. 4A, whose reference ID is “0001” is selected in a list box 601 as the color reference to be measured. When a start button 602 is selected, the color reference selected in the list box 601 is set as the color reference of the target to be measured. On the other hand, when a cancel button 603 is selected, the setting contents of this screen are canceled. When the designation of the color reference selected in the list box 601 is received from the user via the UI control module 301 and the press of the start button 602 is received, the color inspection processing module 302 starts executing the color inspection. Upon receiving the press of the cancel button 603, the color inspection processing module 302 cancels the execution of the color inspection.

In step S502, the color management system 300 transmits an instruction to print and measure the color of the chart data for color inspection to the image processing apparatus 112. At this time, the color inspection processing module 302 obtains the information of the color reference specified in the list box 601. For example, when the reference ID is “0001”, the reference name “JapanColor2011”, the printer “Printer A”, and the allowable values “mean color difference: 2.5, maximum color difference 5” in FIG. 4A are obtained. Further, color patches to be used in the color reference and a reference value information table 406 (FIG. 4B) thereof are obtained. Then, the color inspection processing module 302 creates chart data for color inspection, and transmits the chart data as a print job for color inspection to the image processing apparatus 112 corresponding to the designated “printer A” via the data transmission/reception module 305.

In this way, in step S503, the image processing apparatus 112 transmits an instruction for printing and colorimetry of the received chart data to the image forming apparatus 102, and obtains the color information measured by the image forming apparatus 102. At this time, the print job control module 309 of the image processing apparatus 112 transmits the received instruction to print the chart data for color inspection to the image forming apparatus 102 via the data transmission/reception module 310. Thereby, the CPU 207 of the image forming apparatus 102 performs printing of the received chart data for color inspection, and performs colorimetry on the printed matter using the spectral sensor 107. Then, the CPU 207 of the image forming apparatus 102 transmits the colorimetry result (colorimetry data Lab) to the image processing apparatus 112 via the cable 113. In this way, the image processing apparatus 112 transmits the measured color information to the color management system 300 in step S504. At this time, the color inspection processing module 307 of the image processing apparatus 112 transmits the received colorimetry result (colorimetry data Lab) to the color management system 300 via the data transmission/reception module 310.

In step S505, the color management system 303 receives the measured color information. The data management module 304 of the color management system 300 stores the received colorimetry result (colorimetry data Lab) in the RAM 202. At this time, the colorimetry result (colorimetry data Lab) may be transmitted to the database 117 instead of the color management system 300, and the CPU 242 of the database 117 may store the colorimetry result in the RAM 243. In this case, the data management module 304 of the color management system 300 obtains the colorimetry result (colorimetry data Lab) from the database 117 via the data transmission/reception module 305 and stores it in the RAM 202.

Then, in step S506, the color management system 300 compares the received color information with the reference value and inspects the color quality status. At this time, the color inspection processing module 302 calculates a color difference between the obtained colorimetry result (colorimetry data Lab) and the reference value Lab of the color reference obtained in step S502, and saves the result in the RAM 202. The information saved at this time is, for example, the data illustrated in the above-described FIG. 4C. There are various calculation methods such as CIE 76, CIE 96, CIE 2000, but any calculation formula may be used as the color difference calculation formula. The color inspection processing module 302 calculates the average color difference and the maximum color difference of all of the color patches based on the obtained calculation result of the color difference, and stores the result in the RAM 202. Since the calculation of the average color difference and the maximum color difference is by a typical calculation method, the description thereof will be omitted.

Then, the color inspection processing module 302 compares the calculated average color difference and maximum color difference with the average color difference and maximum color difference of the allowable values of the color reference obtained in step S502, and determines whether or not the average color difference and the maximum color difference exceed the allowable values in step S507. If the average color difference and the maximum color difference do not exceed the respective allowable values, the color quality state is good, and thus the color inspection result is OK. On the other hand, in a case where any one of the average color difference and the maximum color difference exceeds the allowable values, the color quality state is defective, and thus the color inspection result becomes NG and the processing proceeds to step S513. In step S513, the color adjustment processing module 303 determines the color adjustment function to be set to “color adjustment function 1” and proceeds to step S514.

In a case where the average color difference and the maximum color difference do not exceed the allowable values in step S507, the quality level is determined based on the respective differences between the calculated average color difference and maximum color difference and the average color difference and the maximum color difference of the color reference. In this case, quality levels A, B, C, and D are determined in the order from smallest to largest difference.

FIG. 7 depicts a view illustrating an example of a color inspection result screen according to the first embodiment.

A color inspection result screen 701 is displayed on the display unit 205 via the UI control module 301 when the determination process of the color inspection result is completed. Note that configuration may be such that this display is not automatically displayed, and the display may be performed in accordance with an instruction from the user. Reference numeral 702 indicates a determination result (OK, NG, quality level) of the color inspection. Here, the color inspection result indicates that the inspection result is OK and the quality level is A. Reference numeral 703 indicates basic information (the execution date and time, the reference ID, the reference name, and the printer name) of the color inspection. Reference numeral 704 indicates details of the inspection result (the average color difference, the maximum color difference). Reference numeral 705 indicates a colorimetry result for color patches and information of a color difference for each color patch. When the user presses an export button 706, the color inspection result is downloaded in a file format such as PDF or CSV. A close button 707 is a close button for closing the color inspection result screen 701. In step S506, the color management system 300 obtains information related to a color adjustment function to be executed subsequently.

FIG. 8A depicts a view illustrating an example of a color adjustment function table according to the first embodiment, and FIG. 8B depicts a diagram illustrating an example of a table for a relation between color inspection results and color adjustment according to the first embodiment. These pieces of information are saved in the storage unit 244 of the database 117, and the data management module 304 obtains the pieces of information from the database 117 via the data transmission/reception module 305.

Color adjustment function 801 of FIG. 8A indicates color adjustment functions that can be executed by the color management system 300. Here, two types of color adjustment functions, color adjustment function 1 and color adjustment function 2, can be executed. Downtime 802 indicates information about the downtime of the image forming apparatus 102 by the color adjustment function. Here, the color adjustment function 1 has a large downtime (equal to or longer than a predetermined time), and a color adjustment function 2 has a small downtime (shorter than a predetermined time). For example, the color adjustment function 1 is a color adjustment function that stops execution of a print job in the above-described image forming apparatus 102 and performs gradation correction or density correction. Since the color adjustment function 2 is a color adjustment function that performs density correction while executing a print job, downtime is small.

A color inspection result 803 of FIG. 8B indicates OK, NG, and quality levels A to D.

A color adjustment 804 indicates whether or not color adjustment corresponding to each color inspection result is necessary. If color adjustment is necessary, a value of “necessary” is stored, and if it is unnecessary, a value of “unnecessary” is stored. A downtime 805 indicates a downtime when color adjustment is executed. In a case where the color adjustment is “necessary” in the color adjustment 804, the downtime of the color adjustment to be executed is stored. The downtime 805 corresponds to the downtime 802 in FIG. 8A. For example, it is defined that in a case where the color inspection result is OK and the quality level is A, color adjustment is not required, and in a case where the color adjustment result is OK and the quality level is B, color adjustment is required, and the color adjustment function 2, for which downtime is small, is executed. In the example of FIGS. 8A and 8B, the downtime is associated with the color adjustment function to be executed, but if it can be uniquely associated, it may be associated by an ID or the like. The subsequent processing steps of S508 to S513 are processing for performing color adjustment corresponding to the color inspection result. In the example of FIGS. 8A and 8B, when the differences between the average color difference and the maximum color difference of the color reference and the calculated average color difference and maximum color difference are less than level C, a color adjustment with a large downtime is selected. On the other hand, if the differences are greater than or equal to level C, a color adjustment with a small downtime is selected. In other words, if the quality level detected by the color inspection result is greater than or equal to a threshold value, a color adjustment with a small downtime is selected, and if the quality level is lower than the threshold value, a color adjustment with a large downtime is selected.

In step S507, the color management system 300 determines whether the color inspection result is OK or NG. The color inspection processing module 302 determines whether or not the color inspection result is OK based on the result of the color inspection of step S506, and if the color inspection result is OK, the processing proceeds to step S508; if the color inspection result is NG, the processing proceeds to step S513. In step S508, the color management system 300 determines whether the color inspection result quality level is A (the difference between the average color difference and the maximum color difference is a minimum). Here, the color inspection processing module 302, in step S506, determines whether or not the quality level of the color inspection result is A, and if the quality level is A, the processing proceeds to step S509; otherwise the processing proceeds to step S510. In step S509, the color management system 300 determines that the color adjustment function to be set is “unnecessary”. Specifically, the color inspection processing module 302 refers to the color adjustment function table of FIG. 8A and information of the table for the relation between the color inspection result and the color adjustment of FIG. 8B, which are obtained in a preprocessing step, determines that the color adjustment function to be set in a case where the color inspection result is OK and quality level is A is “unnecessary”, and the processing proceeds to step S514.

In step S510, the color management system 300 determines whether the color inspection result quality level is B. Here, the color inspection processing module 302 determines whether or not the quality level of the color inspection result in step S506 is B, and if the quality level is B, the processing proceeds to step S511; otherwise the processing proceeds to step S512. In step S511, the color management system 300 determines that the color adjustment function to be set is “color adjustment function 2”. At that time, the color inspection processing module 302 refers to the color adjustment function table and the information of the table for the relation between the color inspection result and the color adjustment, which are obtained in the preprocessing step, and determines that the color adjustment function to be set in a case where the color inspection result is OK and quality level is B is “color adjustment function 2”, and the processing proceeds to step S514.

In step S512, the color management system 300 determines whether the color inspection result quality level is C. That is, in step S512, the color inspection processing module 302 determines whether or not the quality level of the color inspection result of step S506 is C, and if the quality level is C, the processing proceeds to step S511, and the color adjustment function to be set is determined as “color adjustment function 2” and the processing proceeds to step S514.

On the other hand, if, in step S512, the color inspection result quality level is not C, the processing proceeds to step S513. In step S513, the color management system 300 determines that the color adjustment function to be set is “color adjustment function 1”. At that time, the color inspection processing module 302 refers to the color adjustment function table and the information of the table for the relation between the color inspection result and the color adjustment, which are obtained in the preprocessing step, and determines that the color adjustment function to be set in a case where the color inspection result is OK and quality level is not C, or in a case where the color inspection result is NG, is “color adjustment function 1”, and the processing proceeds to step S514. In step S514, the color management system 300 transmits the setting instruction of the color adjustment function determined in any one of steps S509, S511, and S513 to the image processing apparatus 112. Specifically, the color adjustment processing module 303 transmits the setting instruction of the color adjustment function determined in any one of steps S509, S511, and S513 to the image processing apparatus 112 via the data transmission/reception module 305.

In this way, in step S515, the image processing apparatus 112 sets the color adjustment function of the image processing apparatus 112 by the color adjustment processing module 308 based on the information of the color adjustment function to be set received via the data transmission/reception module 310, and transmits an instruction to execute the color adjustment function to the image forming apparatus 102. At this time, the color adjustment processing module 308 sets the color adjustment function based on the instruction for setting the color adjustment function received by the data transmission/reception module 310 of the image processing apparatus 112. Further, the color adjustment processing module 308 transmits an instruction for setting the color adjustment function to the image forming apparatus 102 via the data transmission/reception module 310. Note that the setting of the color adjustment function in this processing step may be performed simply by skipping the setting processing as long as the setting is the same as the currently set color adjustment function.

Next, the processing proceeds to step S516, and the image processing apparatus 112 and the image forming apparatus 102 execute the received color adjustment function. Specifically, the CPU 235 of the image processing apparatus 112 functions as the color adjustment processing module 308, and executes the color adjustment function based on the received instruction of the color adjustment function. For example, in the case of the “color adjustment function 1”, the execution of the job being printed is suspended, and the execution of the color adjustment is performed. Further, in the case of the “color adjustment function 2”, after a subsequent print job, charts for color inspection are inserted at predetermined intervals while printing is continued, so that a simple adjustment function is executed.

As described above, according to the first embodiment, it is possible to execute the optimal color adjustment processing according to the result of the color inspection. If the color quality state is good, a simple color adjustment function with a small downtime is performed. In this way, it is possible to operate so as to maintain a state in which the color tone is good for as long a period as possible. It is possible to perform control so that color adjustment processing for which downtime is large but that is capable of correcting density of the reproduced color to close to the reference values is executed only in cases where the quality state becomes bad. This makes it possible to maintain the color quality while increasing the productivity of the image forming apparatus as much as possible.

In the first embodiment described above, a screen is displayed when the color inspection is executed, and an instruction to execute the color inspection is received from the user; however, the date and time when the color inspection is to be executed may be set in advance, and the color inspection may be automatically executed when the date and time is reached. By automating the execution of the color inspection, it is possible to automate the execution of the color inspection and optimal color adjustment, and thus it is possible to achieve more efficiency.

In the first embodiment, the color management system 300 is described as on-premises software executed by the client computer 101, but the color management system 300 may be a service executed on the cloud. The function of the color management system 300 may also be executed by the image processing apparatus 112.

Further, in the first embodiment, the color adjustment function to be executed is determined based on the metrics of quality levels A to D of the color inspection; however, the color adjustment process to be executed may be determined based on a difference between the values of the colors of CMYK and Lab and reference values, for example, instead of the abstract concept of the quality level.

### Second Embodiment

A second embodiment of the present invention will be described. Note that descriptions of configurations common to the first embodiment will be omitted. In the second embodiment, a process of switching a setting in accordance with the result of a color inspection, taking an adjustment mode of the color adjustment function into consideration, will be described. Further, the color adjustment function to be set in accordance with the result of the color inspection will be described as being arbitrarily settable by the user.

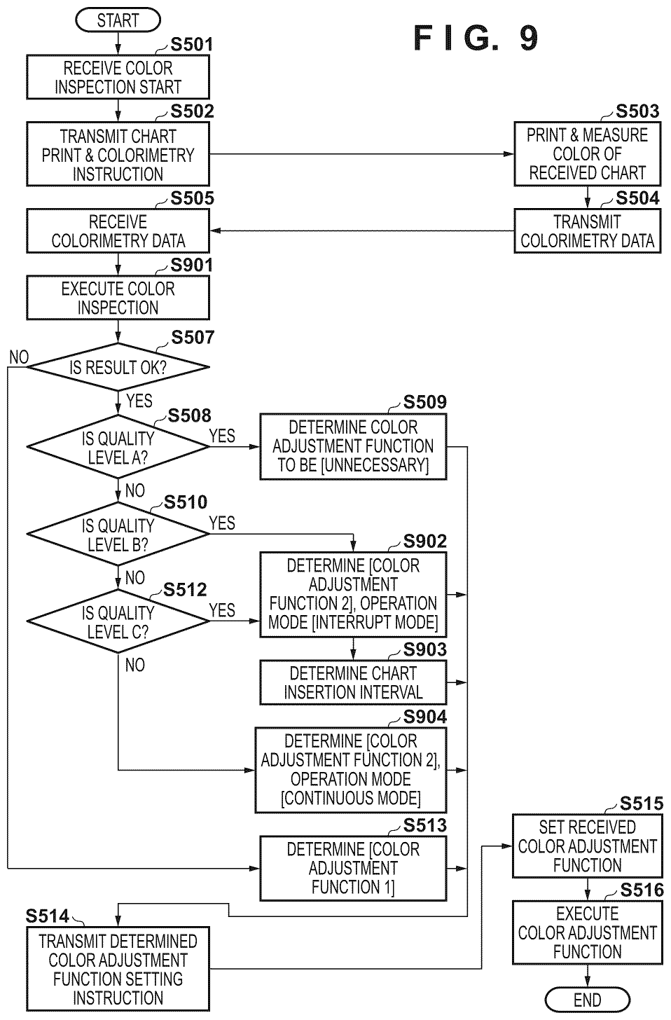

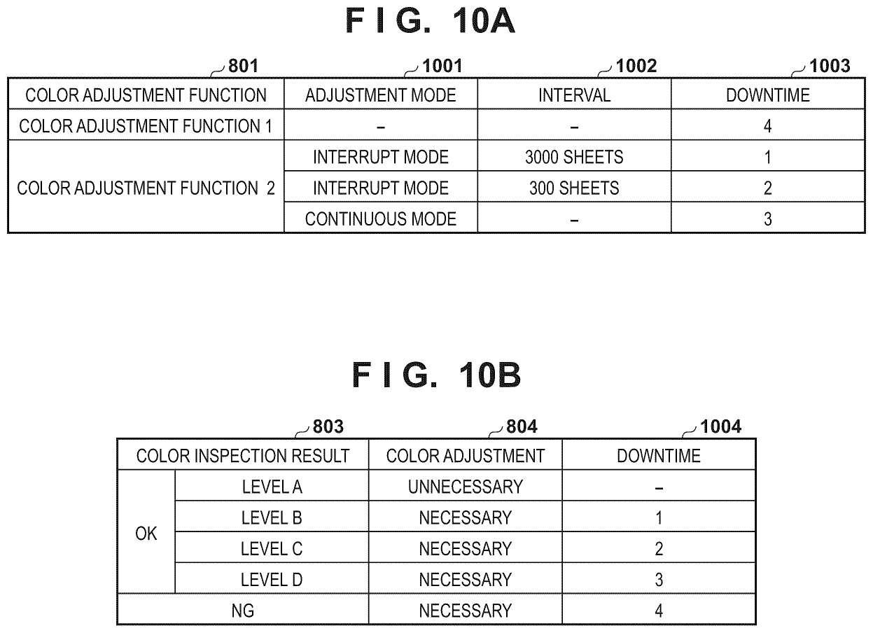

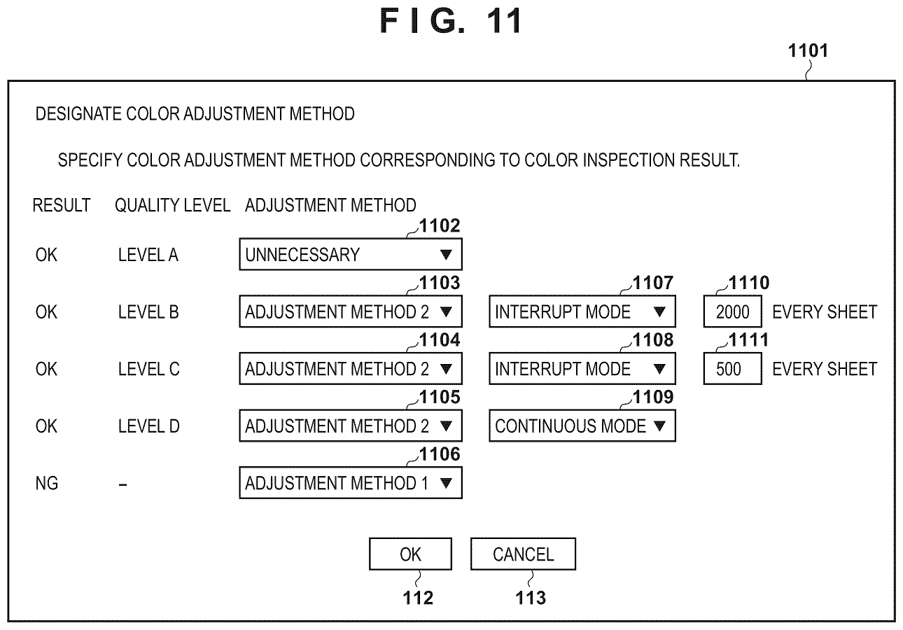

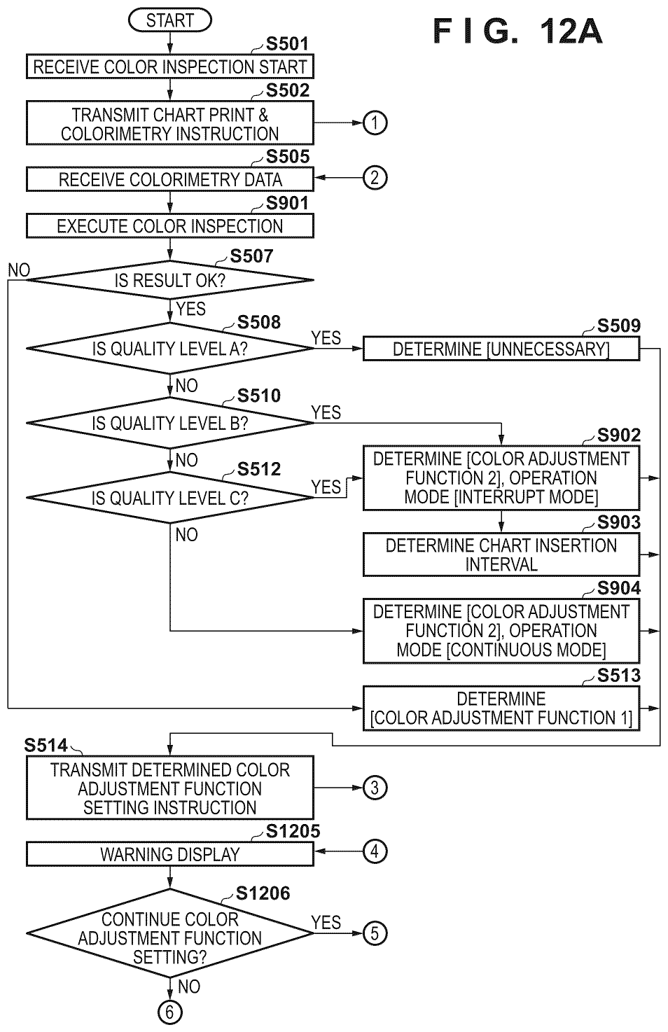

FIG. 9 is a flowchart for describing processing for setting an optimal color adjustment function in accordance with a result of a color inspection in the system, according to the second embodiment. Note that the same reference numerals are used for the same processing as in FIG. 5, and descriptions thereof will be omitted. Each processing step will be described using the color adjustment information of FIG. 10 and the color adjustment setting screen of FIG. 11.

In step S901, the color management system 300 compares the received color information with the reference value and inspects the color quality status. Since the processing steps of the color inspection are the same as those in step S506 described above, explanation thereof will be omitted. Note that the difference from step S506 of previously-described FIG. 5 is that the information related to the color adjustment function to be executed that is obtained is a color adjustment function table illustrated in FIG. 10A and a table for the relation between the color inspection result and the color adjustment illustrated in FIG. 10B. These pieces of information are saved in the storage unit 244 of the database 117, and the data management module 304 obtains the pieces of information from the database 117 via the data transmission/reception module 305.

Differences between the aforementioned FIGS. 8A and 8B and FIGS. 10A and 10B will now be described.

FIG. 10A depicts a view illustrating an example of a color adjustment function table according to according to the second embodiment, and FIG. 10B depicts a view illustrating an example of a table for a relation between color inspection results and color adjustment according to the second embodiment.

An adjustment mode 1001 in FIG. 10A denotes the adjustment mode of the color adjustment function. Here, it is illustrated that there are two types of adjustment modes, “interrupt mode” and “continuous mode”, in the color adjustment function 2. For example, the color adjustment function 2 is a function of performing density correction while executing a print job, but in a case where the color adjustment function is also operated in “interrupt mode”, the color adjustment function is an operation of inserting a color chart at predetermined intervals, performing colorimetry, and correcting density of the reproduced color. On the other hand, in the case of operation in “continuous mode”, a color chart is printed in a margin region of a sheet of a print job, color measurement is performed, and density of the reproduced color is corrected.

An interval 1002 indicates an interval at which the color chart is inserted in a case where the adjustment mode 1001 is “interrupt mode”. In the example of FIG. 10A, there are two types of settings: a setting in which a color chart is inserted every time 3000 sheets are discharged, and a setting in which a color chart is inserted every time 300 sheets are discharged. A downtime 1003 indicates information about the downtime of the image forming apparatus 102 due to the color adjustment function. In FIG. 8A of the first embodiment, two types of downtime are defined (large and small), but downtime settings corresponding to the number of the color adjustment function types is defined, and numerical values therefor are “1” to “4”. The numerical value “1” represents the smallest downtime, and the larger the numerical value, the larger the downtime is, with “4” being the largest.

In the example of FIG. 10A, the downtime of the image forming apparatus 102 is defined to be larger for “continuous mode” than it is for “interrupt mode”. In “continuous mode”, as described above, since the color chart is printed on the margin of a sheet printed by the print job and then color measurement and adjustment processing are performed, downtime due to the adjustment processing does not occur. However, whether or not a blank area for printing a color chart exists in the margin of a sheet printed by the print job varies depending on the type of the job. Therefore, it is necessary for the user to determine whether or not the “continuous mode” can be executed for each print job. Therefore, there is a possibility that the downtime will be large in a case where the adjustment processing is switched. In view of this, in the second embodiment, “continuous mode” is defined to have a larger downtime than “interrupt mode”. However, this may be changed in accordance with the usage environment of the user.

A downtime 1004 of FIG. 10B indicates the downtime when performing the color adjustment corresponding to FIG. 10A. For example, in a case where the color inspection result is OK and the quality level is B, the downtime “1” is obtained from FIG. 10B and the color adjustment function 2 corresponding to downtime “1” in FIG. 10A is executed in “interrupt mode” (color chart insertion every 3000 sheets). In addition, in a case where the color inspection result is OK and the quality level is D, the downtime “3” is obtained from FIG. 10B and the color adjustment function 2 corresponding to downtime “3” in FIG. 10A is executed in “continuous mode”.

FIG. 11 depicts a view illustrating an example of a color adjustment method setting screen 1101 by which to perform a color adjustment method designation, according to the second embodiment. The setting screen 1101 is displayed on the display unit 205 when the UI control module 301 receives a display instruction from the user via a setting menu (not illustrated) or the like of the color management system 300. This screen 1101 allows the user to arbitrarily define which color adjustment function is to be executed in accordance with the result of color inspection indicated by the color adjustment function table in FIG. 10A and the table for the relation between the color inspection result and the color adjustment in FIG. 10B.

A combo box 1102 specifies how to adjust the color in a case where the color inspection result is OK and quality level is A. A combo box 1103 specifies how to adjust the color in a case where the color inspection result is OK and quality level is B. A combo box 1104 specifies how to adjust the color in a case where the color inspection result is OK and quality level is C. A combo box 1105 specifies how to adjust the color in a case where the color inspection result is OK and quality level is D. A combo box 1106 specifies how to adjust the color in a case where the color inspection result is NG. Combo boxes 1107, 1108, and 1109 specify an operation mode of the color adjustment method, that is, “interrupt mode” or “continuous mode”. These are displayed when the color adjustment method in the combo boxes 1102 to 1106 is specified as one for which an operation mode can be specified. Combo boxes 1110 and 1111 specify the chart insertion intervals, which can be specified in a case where the operation mode is “interrupt mode”. The combo boxes 1110 and 1111 are displayed when the operation mode is set to “interrupt mode” in the corresponding combo boxes 1107 to 1109. An OK button 1112 sets the color adjustment function inputted on the setting screen 1101. A cancel button 1113 cancels the setting on the screen 1101. In the example of FIG. 11, a setting is performed such that when the color inspection result is OK and quality level is A, the color adjustment method is “unnecessary”, and when the color inspection result is OK and quality level is B, the color adjustment method is “adjustment method 2”, the operation mode is “interrupt mode” and the chart insertion interval is every “2000” sheets.

In this way, the user can arbitrarily set/change the color adjustment information defined in advance by the color management system 300. In FIGS. 10A and 10B, the downtime 1003 in FIG. 10A and the downtime 1004 in FIG. 10B are used as keys to associate the color inspection result with the color adjustment function. However, in a case where the user is allowed to customize using the setting screen 1101 of FIG. 11, the association is performed by an ID or the like.

Returning to FIG. 9, the color management system 300 determines whether the color inspection result quality level is B in step S510. The color inspection processing module 302 determines whether or not the quality level of the color inspection result determined in step S901 is B, and if the quality level is B, the processing proceeds to step S902. In step S902, the color inspection processing module 302 sets the color adjustment function to be set as “color adjustment function 2” and determines the adjustment mode to be “interrupt mode”. The color inspection processing module 302 refers to the color adjustment function table of FIG. 10A and the information of the table for the relation between the color inspection result and the color adjustment of FIG. 10B, which are obtained in a preprocessing step. Then, it is determined that the color adjustment function to be set is “color adjustment function 2” and the adjustment mode is “interrupt mode” in a case where the color inspection result is OK and quality level is B.

Next, the processing proceeds to step S903, and the color inspection processing module 302 determines a chart insertion interval to be set. The color inspection processing module 302 refers to the color adjustment function table of FIG. 10A and the information of the table for the relation between the color inspection result and the color adjustment of FIG. 10B, which are obtained in a preprocessing step. Then, it is determined that the chart insertion interval to be set is “3000” in a case where the color inspection result is OK and quality level is B. On the other hand, in a case where the color inspection result is OK and quality level is C, it is determined that the chart insertion interval to be set is “300”.

The color management system 300, in step S512, determines whether or not the quality level of the color inspection result is C, and if the quality level is C, the processing proceeds to above-described step S902; otherwise the processing proceeds to step S904. In step S904, the color inspection processing module 302 sets the color adjustment function to be set as “color adjustment function 2” and determines the adjustment mode to be “continuous mode”. The color inspection processing module 302 refers to the color adjustment function table of FIG. 10A and the information of the table for the relation between the color inspection result and the color adjustment of FIG. 10B, which are obtained in a preprocessing step. Then, it is determined that the color adjustment function to be set is “color adjustment function 2” and the adjustment mode is “continuous mode” in a case where the color inspection result is OK and quality level is D.

As described above, according to the second embodiment, the adjustment mode of the color adjustment function is set in accordance with the result of the color inspection, and furthermore the optimal color adjustment processing can be executed in consideration of the difference in the downtime of the image forming apparatus. In addition, since the user can customize the color adjustment function to be set according to the result of the color inspection, the color adjustment function can be set more flexibly according to the user environment.

### Third Embodiment

A third embodiment of the present invention will be described. Note that description of the same configuration as in the first embodiment and the second embodiment will be omitted. In the third embodiment, in a case where the adjustment mode of the color adjustment function described in the second embodiment is “continuous mode”, the process of displaying a warning in accordance with the margin state of the print job of the image forming apparatus 102 will be described.

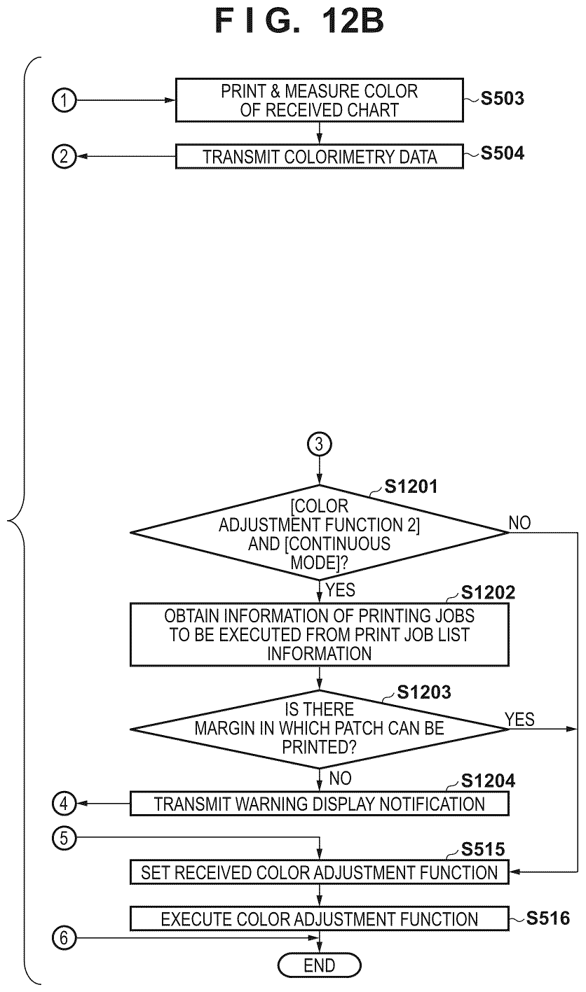

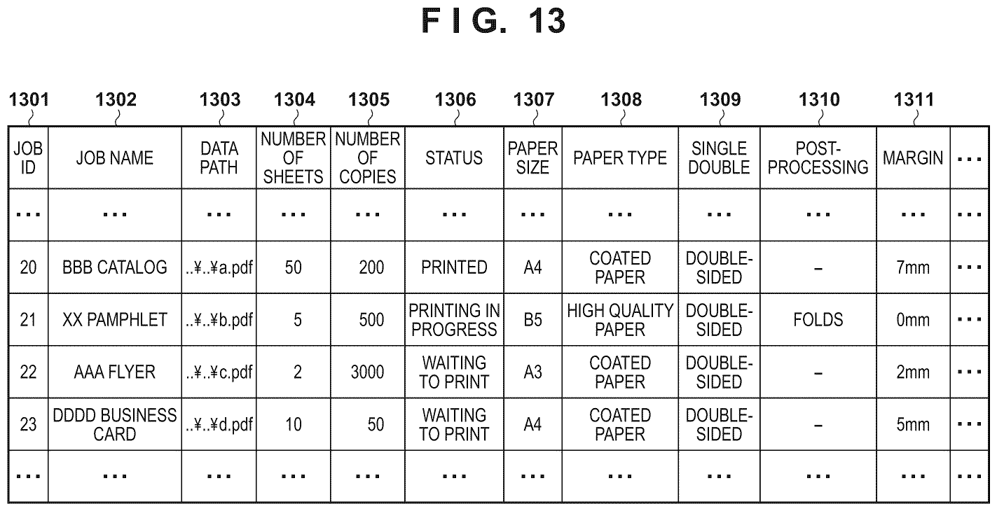

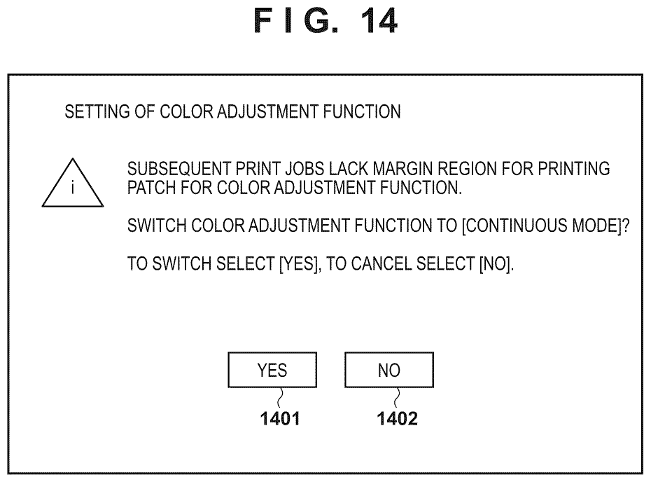

FIGS. 12A and 12B are flowcharts for describing processing for setting an optimal color adjustment function in accordance with a result of a color inspection in the system, according to the third embodiment. In FIGS. 12A and 12B, the same reference numerals are used for the same processes as those in previously-described FIG. 5 and FIG. 9, and their descriptions are omitted. The respective processing steps will be described using the print job list information of FIG. 13 and the warning screen of FIG. 14.

In step S514, the color management system 300 transmits the instruction to set the color adjustment function determined in any one of step S509, step S513, and step S902 to step S904 to the image processing apparatus 112. Then, in step S1201, the CPU 207 of the image forming apparatus 102 functions as the color adjustment processing module 308, and determines whether the received color adjustment function is “color adjustment function 2” and the adjustment mode is “continuous mode”. Here, if the color adjustment function to be set received via the data transmission/reception module 310 is “color adjustment function 2” and the adjustment mode is “continuous mode”, the processing proceeds to step S1202, and if it is not the case that the color adjustment function is “color adjustment function 2” and the adjustment mode is “continuous mode”, the processing proceeds to step S515.

In step S1202, the CPU 207, functioning as the data transmission/reception module 310, obtains print job list information in which information of a print job held by the image processing apparatus 112 is stored, and obtains information of a print job to be printed by the image forming apparatus 102. At this time, the data transmission/reception module 310 obtains print job list information saved in the database 117 via the network 118.

FIG. 13 depicts a view illustrating an example of a list of print jobs which are processed on the image processing apparatus 112 which is saved in the database 117, according to the third embodiment.

A job ID 1301 is identification information for uniquely specifying the print job, a job name 1302 is a name of the print job, and a data path 1303 is a reference path to the print job data. A number of sheets 1304 is the number of output sheets per job; the number of copies 1305 is the number of copies to be printed in the job; and a status 1306 is the status of the print job, and any one of “printing in progress”, “printing completed”, and “waiting for printing” is stored therein. A paper size 1307 is the paper size to be output in the print job, a paper type 1308 is the paper type to be used in the print job, and single-sided 1309 is the setting information for single-sided or double-sided printing. Post-processing 1310 indicates setting information for post-processing such as bookbinding, and margin 1311 indicates margin information of a sheet of paper on which to print in a print job.

The status 1306 indicates the status of the print job, “printed” indicates that printing has been completed by the image forming apparatus 102, “printing in progress” indicates that printing is currently being performed, and “waiting for printing” indicates that printing has not yet been performed. The margin 1311 indicates information on the upper, lower, left, and right margin regions on the print sheet surface of the print job. Note that configuration may be such that the margin 1311 is not held in the print job list information, but rather how many mms of margin there will be is calculated on the system side by using the print job data referred to in the data path 1303, the paper size 1307, and layout information (not illustrated).

The print job control module 309 determines that a print job whose status 1306 in the print job list information is “waiting for printing” and whose job ID 1301 is the smallest is the job to be printed by the image forming apparatus 102 next. In the example of FIG. 13, since there are two job IDs 1301 “22” and “23” for which the status 1306 is “waiting for printing”, it is determined that the print job having the job ID 1301 of “22” is to be printed by the image forming apparatus 102 next. Note that, although the job IDs are printed in ascending order, a value indicating the print order may be defined separately from the job ID. The reason why the information of the print job to be printed next is obtained in step S1202 is that in a case where the color adjustment function received in step S1201 is set, it is the next print job for which it becomes valid. If the timing at which the setting of the color adjustment function becomes valid is immediate, the job information for which the status 1306 is “printing in progress” may be obtained in step S1202.

Next, the processing proceeds to step S1203 and the CPU 207 functions as the print job control module 309 to determine whether or not the margin 1311 of the obtained print job information is greater than or equal to a threshold value. At this time, the print job control module 309 obtains the margin 1311 of the print job information obtained in step S1202, compares the margin with a threshold value defined in advance in the system, determines that there is a margin in which a color patch can be printed if the margin 1311 is larger than the threshold value, and the processing proceeds to step S515. On the other hand, if the margin 1311 is smaller than the threshold value, it is determined that there is no margin in which a color patch can be printed, and the processing proceeds to step S1204. In the example of FIG. 13, “2 mm”, which is the margin 1311 of the job ID 1301 whose value is “22”, is obtained, and it is determined that there is no margin in which a color patch can be printed, for example, in a case where the threshold value is 5 mm.

In step S1204, the CPU 207 functions as the color adjustment processing module 308 and transmits a warning display notification to the color management system 300 to warn that there is no margin in which a color patch can be printed. At this time, the color adjustment processing module 308 transmits the warning display notification to the color management system 300 via the data transmission/reception module 310.

Accordingly, in step S1205, the color management system 300 displays the warning screen based on the received the warning display notification. At this time, the UI control module 301 displays a warning screen on the display unit 205 based on the warning display notification received via the data transmission/reception module 305.

FIG. 14 depicts a view illustrating an example of a warning screen displayed on the display unit 205 of the client computer 101, according to the third embodiment.

This warning screen warns that the color patch used in the “continuous mode” cannot be printed on the margin of the print job when setting the color adjustment function to “color adjustment function 2” and the adjustment mode to “continuous mode”. When the mode is automatically switched to “continuous mode”, since there is a possibility that a color patch will be printed on the printing surface and a printing error will occur, a warning is displayed in advance in this manner to convey this fact to the user.

Then, the processing proceeds to step S1206, and the CPU 207 determines whether to continue the setting of the color adjustment function. At this time, the CPU 207 functions as the UI control module 301, and in a case where the user confirms on the warning screen and designates “Yes” 1401, it is determined that the setting of the color adjustment function is to be continued, and the processing proceeds to step S515. On the other hand, in a case where “No” 1402 is designated, it is determined to cancel the setting of the color adjustment function, and the processing of this flowchart is ended.

As described above, according to the third embodiment, when the adjustment mode of the color adjustment function is set to “continuous mode” in accordance with the result of the color inspection, it is possible to display a warning to the user in view of the margin of a sheet printed by the print job. Accordingly, it is possible to automatically prevent a color patch for adjustment from being printed when a print job for printing a sheet having no margin is executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-108521, filed Jun. 30, 2023, which is hereby incorporated by reference herein in its entirety.

What is claimed is:

1. A method of controlling an information processing apparatus, the method comprising:
controlling execution of a color inspection for inspecting a color quality state at a time of printing in an image forming apparatus;
controlling to determine one of a plurality of color adjustment processes for adjusting the color quality state of the image forming apparatus in accordance with the quality state determined by the color inspection, where downtimes of the image forming apparatus differ for each of the color adjustment processes from each other; and
causing the image forming apparatus to execute the determined color adjustment processes.

2. The method according to claim 1 wherein, in the controlling to determine one color adjustment process among the plurality of color adjustment processes, if the quality state is less than a threshold value, a first color adjustment process for which the downtime is equal to or longer than a predetermined time is determined to be caused to be executed, and if the quality state is greater than or equal to the threshold value, a second color adjustment process for which the downtime is shorter than the predetermined time is determined to be caused to be executed.

3. The method according to claim 1, wherein in the color inspection, the quality state is inspected by causing the image forming apparatus to print a chart in which color patches for color inspection are arranged, reading the chart and calculating an average color difference and a maximum color difference of the color patches, and comparing the average color difference and the maximum color difference against an average color difference and a maximum color difference of a color reference.

4. The method according to claim 3, wherein, in the controlling to determine one of the plurality of color adjustment processes, a quality level is determined based on differences between the calculated average color difference and maximum color difference and the average color difference and maximum color difference of the color reference, and the image forming apparatus is caused to execute one color adjustment process among the plurality of color adjustment processes based on the determined quality level.

5. The method according to claim 2, wherein the first color adjustment process is a color adjustment process in which execution of a print job of the image forming apparatus is stopped and the color quality state is adjusted, and the second color adjustment process is a color adjustment process in which the color quality state is adjusted while continuing execution of a print job of the image forming apparatus.

6. The method according to claim 3, wherein, in the controlling to determine one of the plurality of color adjustment processes, even in a case where the calculated average color difference and maximum color difference satisfy the allowable values of the color reference, the image forming apparatus is determined to be caused to execute one color adjustment process among the plurality of color adjustment processes in accordance with the quality state.

7. The method according to claim 3, wherein, in the controlling to determine one of the plurality of color adjustment processes, in a case where the calculated average color difference and maximum color difference do not satisfy the allowable values of the color reference, the image forming apparatus is determined to be caused to execute a first color adjustment process for which the downtime is equal to or longer than a predetermined time.

8. The method according to claim 3, wherein the plurality of color adjustment processes have a first adjustment mode in which the chart for color inspection is inserted at predetermined intervals and the color quality state in printing is adjusted, and a second adjustment mode in which a color patch for color inspection is printed on a top, bottom, left, or right margin region on a surface of a print sheet printed in a print job and the color quality state in printing is adjusted.

9. The method according to claim 3, wherein, in the controlling to determine one of the plurality of color adjustment processes, a quality level is determined based on differences between the calculated average color difference and maximum color difference and the average color difference and maximum color difference of the color reference, and the color adjustment process that the image forming apparatus is to be caused to execute and a first adjustment mode or a second adjustment mode are determined based on the determined quality level.

10. The method according to claim 8, further comprising setting a color adjustment process to be caused to be executed, the first adjustment mode, and the second adjustment mode based on the determined quality level.

11. The method according to claim 10, wherein in the setting, the predetermined intervals are further set.

12. The method according to claim 8, further comprising, in a case where the second adjustment mode is set, obtaining upper, lower, left, and right margin information on a surface of a print sheet printed by the image forming apparatus, and if there is no margin region greater than or equal to a threshold value, displaying a warning screen for allowing a user to confirm the color adjustment process.

13. A printing system comprising an information processing apparatus and an image forming apparatus for executing a print job from the information processing apparatus and performing printing,
the information processing apparatus comprising: one or more first controllers including one or more first processors and one or more first memories, the one or more first controllers configured to:
control execution of a color inspection for inspecting a color quality state at a time of printing in an image forming apparatus;
control to determine one of a plurality of color adjustment processes for adjusting the color quality state of the image forming apparatus in accordance with the quality state determined by the color inspection, where downtimes of the image forming apparatus differ for each of the color adjustment processes from each other; and
make an instruction to the image forming apparatus to execute the determined, color adjustment processes, and
the image forming apparatus comprising: one or more second controllers including one or more second processors and one or more second memories, the one or more second controllers configured to:
execute the color adjustment process that the information processing apparatus instructed.

14. The printing system according to claim 13, wherein, in the controlling to determine one of the plurality of color adjustment processes, the one or more first controllers, if the quality state is less than a threshold value, determine a first color adjustment process for which the downtime is equal to or longer than a predetermined time to be caused to be executed, and if the quality state is greater than or equal to the threshold value, determine a second color adjustment process for which the downtime is shorter than the predetermined time to be caused to be executed.

15. The printing system according to claim 13, wherein in the color inspection, the one or more first controllers inspect the quality state by causing the image forming apparatus to print a chart in which color patches for color inspection are arranged, reading the chart and calculating an average color difference and a maximum color difference of the color patches, and comparing the average color difference and the maximum color difference against an average color difference and a maximum color difference of allowable values of a color reference.

16. The printing system according to claim 15, wherein, in the controlling to determine one of the plurality of color adjustment processes, the one or more first controllers determine a quality level based on differences between the calculated average color difference and maximum color difference and the average color difference and maximum color difference of the color reference, and determine to cause the image forming apparatus to execute one color adjustment process among the plurality of color adjustment processes based on the determined quality level.

17. The printing system according to claim 14, wherein the first color adjustment process is a color adjustment process in which execution of a print job of the image forming apparatus is stopped and the color quality state is adjusted, and the second color adjustment process is a color adjustment process in which the color quality state is adjusted while continuing execution of a print job of the image forming apparatus.

18. A non-transitory computer-readable storage medium that stores one or more programs including instructions, which when executed by one or more processors of an information processing apparatus, cause the information processing apparatus to perform a method, the method comprising:
controlling execution of a color inspection for inspecting a color quality state at a time of printing in an image forming apparatus;
controlling to determine one of a plurality of color adjustment processes for adjusting the color quality state of the image forming apparatus in accordance with the quality state determined by the color inspection, where downtimes of the image forming apparatus differ for each of the color adjustment processes from each other; and
making an instruction to the image forming apparatus to execute the determined color adjustment processes.

19. An information processing apparatus, comprising: one or more controllers including one or more processors and one or more memories, the one or more controllers configured to:
control execution of a color inspection for inspecting a color quality state at a time of printing in an image forming apparatus;
control to determine one of a plurality of color adjustment processes for adjusting the color quality state of the image forming apparatus in accordance with the quality state determined by the color inspection, where downtimes of the image forming apparatus differ for each of the color adjustment processes from each other; and
make an instruction to the image forming apparatus to execute the determined color adjustment.
